(19) United States
(12) Patent Application Publication
(10) Pub. No.: US 2008/0130319 A1
(43) Pub. Date: Jun. 5, 2008

(54) Dot structure of a light guide board

(76) Inventors: Kuo Chia Hsung, Taichung City (TW); Chong Yang Fang, Sinying City (TW); Kao Jui Huang, Dali City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,630

(22) Filed: Mar. 8, 2005

(30) Foreign Application Priority Data
Mar. 10, 2004 (TW) 093106406

(51) Int. Cl. G02B 6/00

(52) U.S. Cl. 362/626

(57) ABSTRACT

A dot structure of a light guide board including a front surface formed with multiple dot structures for guiding the light. Each dot structure has a face formed with multiple light guide fine structures for enhancing the light guide efficiency. Therefore, the light guide board can achieve both of high light guide efficiency and good uniformity of brightness.

### BACKGROUND OF THE INVENTION

The present invention is related to a dot structure of a light guide board. The dot structure is a combination of geometrical fine structures capable of achieving both of high light guide efficiency and good uniformity of brightness.

FIG. 8 shows a conventional light guide board 8. One face of the light guide board 8 is formed with a light guide structure 81 for enhancing light guide efficiency and the uniformity of brightness of the outgoing light. The light guide structure 81 is generally a single geometric structure such as V-shaped groove structure (as shown in FIG. 8), semispherical structure, conic dot structure, column-shaped structure, etc. Alternatively, the light guide structure 81 can be an irregular scattering structure.

The respective shapes of light guide fine structures have their advantages and shortcomings. For example, the V-shaped groove structure has higher light guide efficiency. However, the manufacturing procedure of such V-shaped groove structure is complicated and the cost is higher. In addition, the uniformity of brightness of the outgoing light can be hardly adjusted. The manufacturing time of the irregular scattering reflection structure is shorter and the cost for such structure is lower. However, it is hard to control the manufacturing procedure and the light guide efficiency of such scattering structure is lower.

With respect to the V-shaped groove light guide structure 81 as shown in FIG. 8, in order to adjust the uniformity of the brightness of the outgoing light, the density of the light guide structures 81 is such designed that the farther the light guide structures 81 are away from the incident surface 82, the more closely the light guide structures 81 are arranged. However, such design can only adjust the uniformity of brightness at the direction normal to the incident surface 82. The adjustment effect is still insufficient.

FIG. 9 shows a scattering reflection light guide structure 91 formed by etching. It is hard to control the etching procedure for forming the irregular rough face. When the light is incident upon the irregular rough face, the light is scattered to help in enhancing the uniformity of the outgoing light. However, the light cannot be focused to the view angle so that the brightness will be reduced.

Therefore, the existent various types of light guide fine structures can hardly achieve both of high light guide efficiency and good uniformity of brightness.

### SUMMARY OF THE INVENTION

It is therefore a primary object of the present invention to provide a dot structure of a light guide board including a front surface formed with multiple dot structures. Each dot structure has a face formed with multiple light guide fine structures for enhancing the light guide efficiency. Therefore, the light guide board can achieve both of high light guide efficiency and good uniformity of brightness.

According to the above object, the light guide board of the present invention includes:

an incident surface upon which a light is incident into the light guide board;

a front surface adjacent to the incident surface, the front surface being formed with multiple dot structures for guiding the light, each dot structure having a face formed with multiple light guide fine structures; and

an outgoing surface from which the light outgoes.

The present invention can be best understood through the following description and accompanying drawings wherein:

### BRIEF DESCRIPTION OF THE DRAWINGS

FIG. 1 is a perspective view of a first embodiment of the present invention;

FIG. 2 is an enlarged view of the dot structure of the present invention according to FIG. 1;

FIG. 3 shows the reflection of light inside the light guide board of the present invention;

FIG. 4 shows that the light is many times reflected by the dot structures and the light guide fine structures inside the light guide board of the present invention;

FIG. 5 is an enlarged view showing another embodiment of the present invention, in which the light guide fine structures of the dot structure are U-shaped groove structures;

FIG. 6 is an enlarged view showing still another embodiment of the present invention, in which the light guide fine structures of the dot structure are semispherical dent structures;

FIG. 7 is an enlarged view showing still another embodiment of the present invention, in which the dot structure protrudes from the front surface of the light guide board of the present invention;

FIG. 8 is a perspective view of a conventional light guide board; and

FIG. 9 shows that the light is scattered by the scattering surface of the conventional light guide board.

### DETAILED DESCRIPTION OF THE PREFERRED EMBODIMENTS

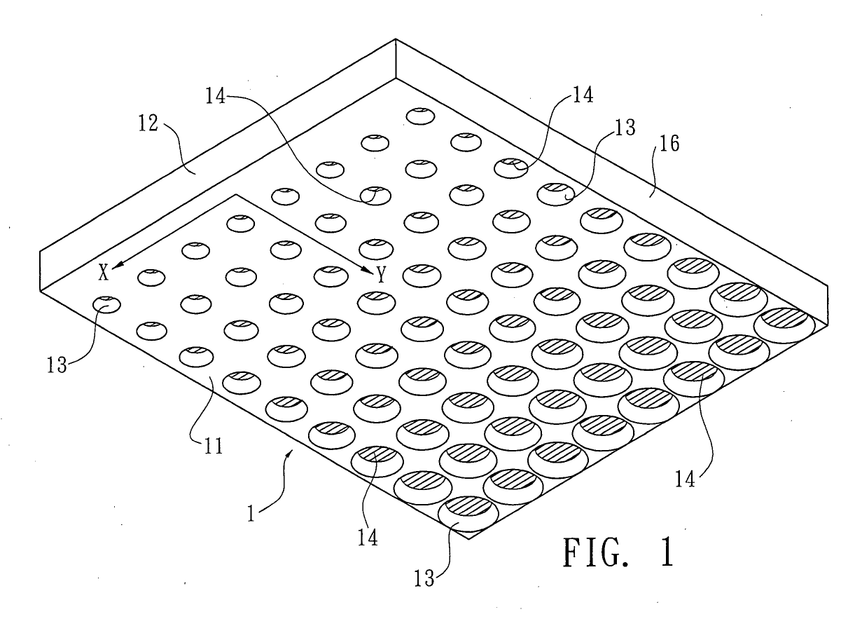

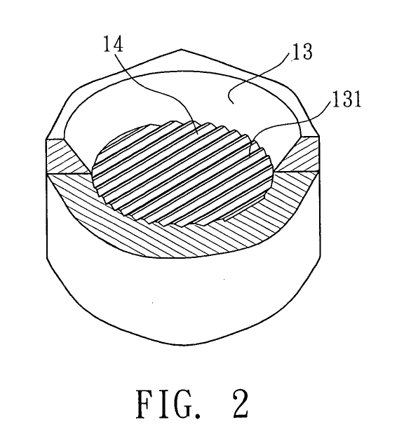

Please refer to FIGS. 1 to 3. The light guide board 1 of the present invention has a front surface 11 and an incident surface 12 adjacent to the front surface 11. A surface opposite to the incident surface 12 and two lateral surfaces adjoining with two sides of the incident surface 12 are defined as reflective surfaces 16. The reflective surfaces 16 are adjacent to the front surface 11. A surface opposite to the front surface 11 is a back surface 15 which is adjacent to the incident surface 12 and the three reflective surfaces 16.

The front surface 11 is formed with multiple dot structures 13 recessed toward the back surface 15. In this embodiment, each dot structure 13 has a conic shape. The areas of the dot structures 13 are such varied that the closer to the incident surface 12 the dot structures 13 are, the smaller the dot structures 12 are, that is, the farther from the incident surface 12 the dot structures 13 are, the larger the dot structures 13 are. In addition, the dot structures 13 are such sequentially arranged that the smaller the dot structures 13 are, the farther from each other the dot structures 13 are, that is, the larger the dot structures 13 are, the closer to each other the dot structures 13 are. Each dot structure 13 has a face 131 far from the front surface 11. The face 131 is formed with multiple light guide fine structures 14. In this embodiment, the light fine structures 14 are V-shaped groove structures extending in the same direction as the incident surface 12.

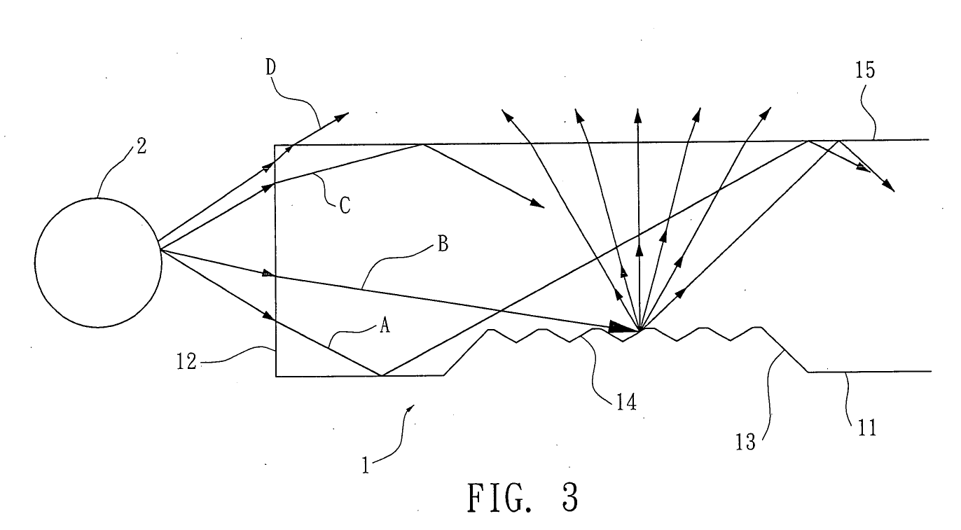

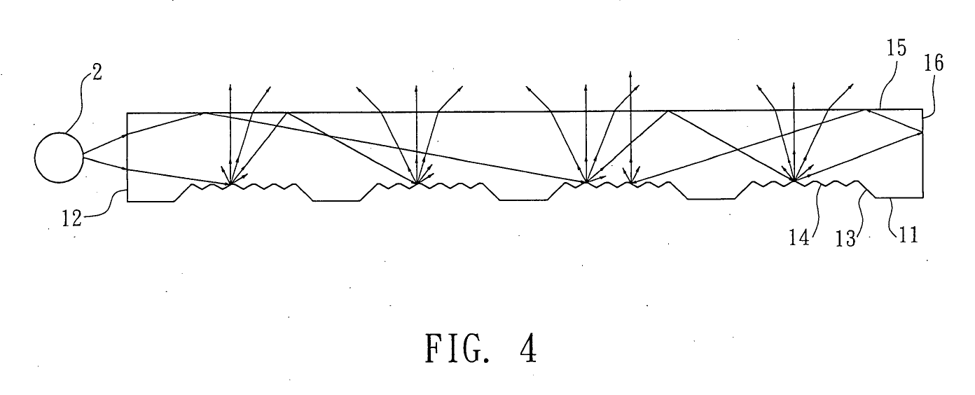

Please refer to FIG. 3 which shows the reflection of the light inside the light guide board 1 of the present invention. After the light of the light source 2 enters the light guide board 1 from the incident surface 12, part of the light A will be projected to the front surface 11 by smaller angle and reflected by the front surface 11 to the back surface 15 and further reflected to the front surface 11. Referring to FIG. 4, the light can be many times reflected inside the light guide board 1. Other part of light B is projected to the light guide fine structures 14 of the dot structures 13. The light guide fine structures 14 guide the light into normal light which trends to a normal direction of the back surface 15 of the light guide board. Still other part of the light C is directly projected to the back surface 15 by smaller angle and reflected to one side distal from the incident surface 12. Still part of light D is projected to the back face 15 by larger angle and directly passes through and outgoes from the back surface 15.

The closer to the incident surface 12 the dot structures 13 are, the smaller that the dot structures 13 are. In addition, the dot structures 13 are such sequentially arranged that the smaller the dot structures 13 are, the farther from each other the dot structures 13 are. Accordingly, the dot structures 13 near the incident surface 12 have smaller areas and are arranged at larger intervals. Therefore, most of the light will be reflected to one side distal from the incident surface 12, while part of the light is projected to the light guide fine structures 14 of the dot structures 13 and then guided into normal light which passes through and outgoes from the back surface 15. The dot structures 13 away from the incident surface 12 have larger areas and are arranged at smaller intervals. Therefore, most of the light is projected to the light guide fine structures 14 of the dot structures 13 and then guided into normal light which passes through and outgoes from the back surface 15.

According to the arrangement of the dot structures 13 of the present invention, the distribution areas of the dot structures 13 can be adjusted in X axis and Y axis of the front surface 11 (as shown in FIG. 1). Therefore, the uniformity of brightness of the outgoing light can be adjusted. Moreover, the light guide fine structures 14 of the dot structures 13 can effectively guide the light into normal light to pass through and outgo from the back surface 15. Therefore, the light guide efficiency of the light guide board 1 can be enhanced. In other words, the dot structure 13 of the present invention is a combination of geometrical fine structures. Therefore, the present invention can achieve both of high light efficiency and good uniformity of brightness.

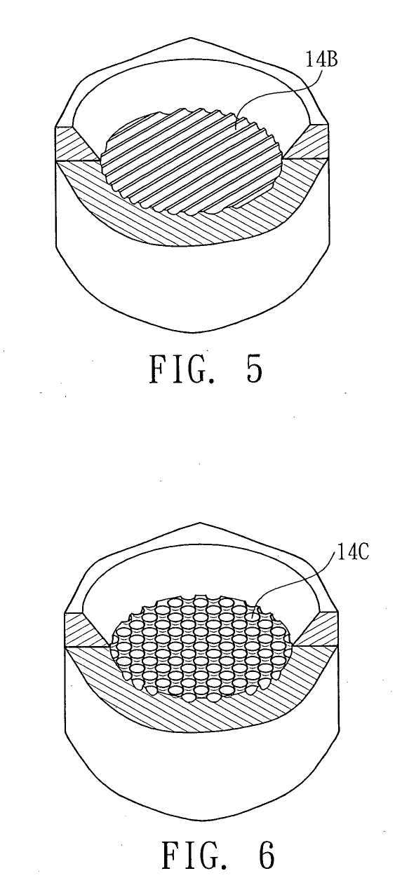

FIG. 5 shows another embodiment of the present invention, in which the light guide fine structures 14B of the face of the dot structure are U-shaped groove structures. FIG. 6 shows still another embodiment of the present invention, in which the light guide fine structures 14C of the face of the dot structure are semispherical dent structures. The light guide fine structures 14B, 14C of FIGS. 5 and 6 can as well effectively guide the light into normal light to achieve the same function as the first embodiment.

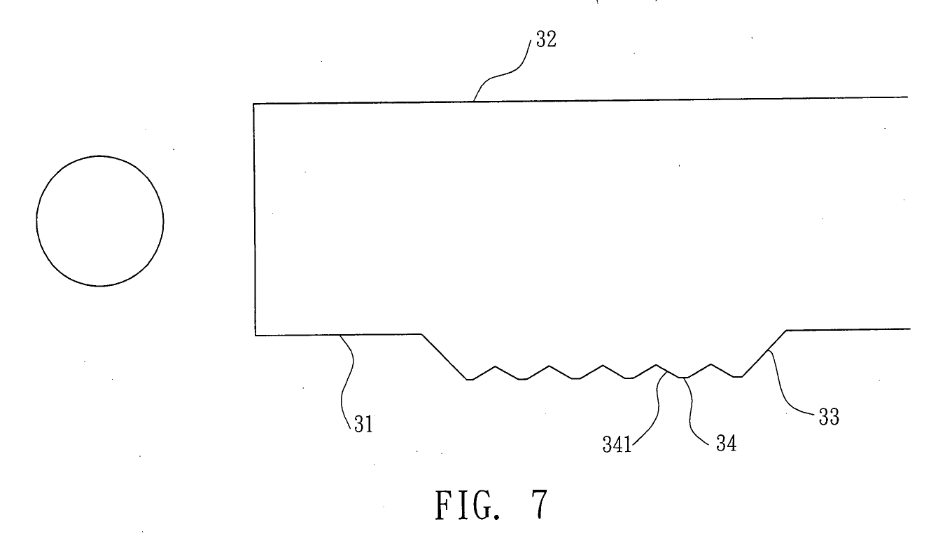

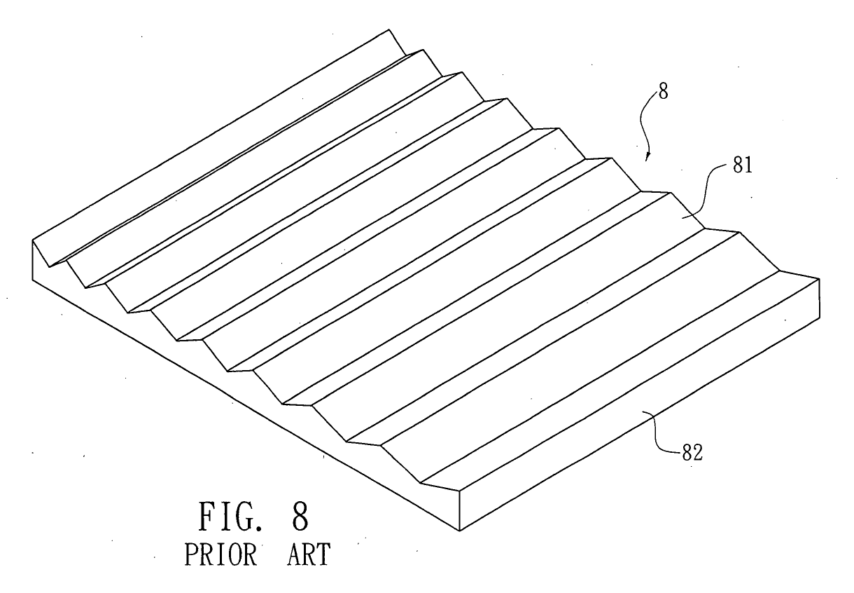

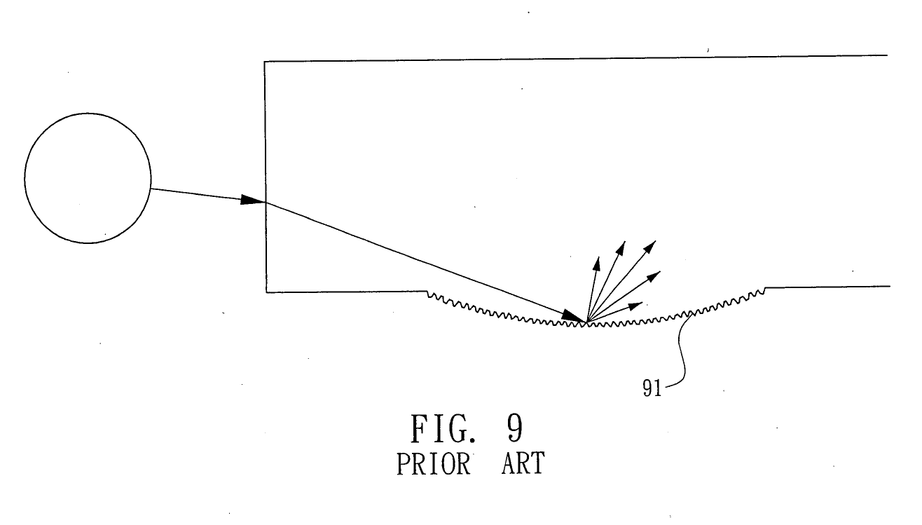

FIG. 7 shows still another embodiment of the present invention, in which the front surface 31 has multiple dot structures 33 protruding from the front face 31 away from the back surface 32. Each dot structure 33 has a conic pattern with a face 34. Multiple light guide fine structures 341 are formed on the face 34. This embodiment can achieve the same function as the first embodiment.

The above embodiments are only used to illustrate the present invention, not intended to limit the scope thereof. Many modifications of the above embodiments can be made without departing from the spirit of the present invention.

What is claimed is:

1. A dot structure of a light guide board comprising:
an incident surface upon which a light is incident into the light guide board;
a front surface adjacent to the incident surface, the front face being formed with multiple dot structures for guiding the light, each dot structure having a face formed with multiple light guide fine structures; and
a back surface from which the light outgoes, the back surface being adjacent to the incident surface, the back surface and the front surface being respectively positioned on two opposite sides of the incident surface.

2. The dot structure of the light guide board as claimed in claim 1, wherein each dot structure has a hole recessed from the front surface toward the back surface.

3. The dot structure of the light guide board as claimed in claim 1, wherein each dot structure has a bump protruding from the front surface.

4. The dot structure of the light guide board as claimed in claim 2, wherein the light guide fine structures of the face of the dot structure are V-shaped groove structures.

5. The dot structure of the light guide board as claimed in claim 2, wherein the light guide fine structures of the face of the dot structure are U-shaped groove structures.

6. The dot structure of the light guide board as claimed in claim 2, wherein the light guide fine structures of the face of the dot structure are semispherical dent structures.

7. The dot structure of the light guide board as claimed in claim 3, wherein the light guide fine structures of the face of the dot structure are V-shaped groove structures.

8. The dot structure of the light guide board as claimed in claim 3, wherein the light guide fine structures of the face of the dot structure are U-shaped groove structures.

9. The dot structure of the light guide board as claimed in claim 3, wherein the light guide fine structures of the face of the dot structure are semispherical dent structures.
